(19) United States
(12) Patent Application Publication
(10) Pub. No.: US 2011/0214999 A1
(43) Pub. Date: Sep. 8, 2011

(54) METHOD AND PROCESS FOR ELEMENT AND/OR COMPOUND EXTRACTION, SEPARATION, AND PURIFICATION

(76) Inventors: Francis A. Nottke, Tucson, AZ (US); Jennifer Jeong, Phoenix, AZ (US); James A. Kirchoff, Tucson, AZ (US); Robert Koeneman, Destin, FL (US); Jose L. Marques, Scarsdale, NY (US); Randolph E. Seligmann, Tucson, AZ (US); Peter D. Vasquez, Tucson, AZ (US)

(21) Appl. No.: 13/043,408

(22) Filed: Mar. 8, 2011

Related U.S. Application Data
(60) Provisional application No. 61/311,484, filed on Mar. 8, 2010.

(51) Int. Cl. B01D 57/00

(52) U.S. Cl. 205/687

(57) ABSTRACT

Embodiments of the invention are directed to apparatus and methods for separating and extracting one or more desired elements and/or compounds from a source feedstock comprising the steps of providing a cavitation-assisted electrolytic purification apparatus comprising an electrolyte and a source feedstock in a reaction zone; introducing oxidizing agents and reducing agents to the source feedstock; causing an electric current to flow through the reaction zone; causing cavitation within the reaction zone; and optionally modifying the temperature of the reaction zone.

### CROSS REFERENCE TO RELATED APPLICATIONS

This application claims priority to U.S. Provisional Application No. 61/311,484, filed Mar. 8, 2010, the contents of which are incorporated by reference herein in their entirety.

### FIELD OF THE INVENTION

The present invention generally relates to an efficient method and process of extracting, separating, or purifying elements and compounds.

### BACKGROUND OF THE INVENTION

Extracting and separating pure elements or compounds from a source feedstock is a goal for many different industries. However, current methods and processes utilized to accomplish this goal are cost intensive in terms of (i) the amount of energy required to perform the method or process, (ii) the lengthy amount of time required to perform the method or process, and (iii) the negative environmental impacts associated with the method or process. For example, in the mining industry, separating the valuable elements or compounds from ore can be extremely expensive, often preventing mining in areas where valuable elements or compounds are known to exist. Additionally, in the gold mining industry, the environmental damage caused by the use of mercury and cyanide to separate the gold from the ore is well documented.

In other industries, such as the solar industry, the high energy cost of producing ultra-pure silicon solar cells prevents the widespread adoption of solar technology. A common method of creating solar cells is the Czochralski process. In the Czochralski process, coal, coke, and wood chips are heated together with silica dioxide. The resulting silicon is then melted in a Czochralski crystal puller at 1400 C and then allowed to slowly crystallize to form a single ingot of silicon. The ingot is then sliced to the required thickness. The energy required to produce one kilogram of ultra-pure, solar-grade silicon from the Czochralski process is over 500 kWh.

Thus, a method and process is needed that can promote the extraction and separation of elements and compounds from a source feedstock while decreasing (i) the energy required to extract or separate the element or compound, (ii) the time to produce the desired element or compound, and (iii) the environmental impact of the extraction and separation.

### SUMMARY OF THE INVENTION

The present invention is a method and process for separating and extracting a given element or compound from a source feedstock. A source feedstock located in a reaction zone is treated by first providing a cavitation-assisted electrolytic purification apparatus comprising an electrolyte and a source feedstock in a reaction zone; introducing element- or compound-specific oxidizing and reducing agents; causing an electric current to flow through the reaction zone, causing cavitation to occur within the reaction zone, and optionally applying element- or compound-specific heat or cold to the reaction zone. These steps may occur either serially with any individual step or combination of the steps occurring before any other individual step or combination of the steps. Alternatively, all steps may occur simultaneously. The result of applying the method and process to the source feedstock is the extraction and separation of the given element or compound from the source feedstock at significantly reduced energy input requirements and reduced time compared to other current extraction and separation methods.

### BRIEF DESCRIPTION OF THE DRAWINGS

FIG. 1 is a flowchart depicting a first embodiment of the method and process according to the present invention.

FIG. 2 is a flowchart depicting a second embodiment of the method and process according to the present invention.

FIG. 3 is a diagram showing the method and process according to the present invention applied to a silicon production process.

FIG. 4 is a diagram of a first embodiment of the cavitation-assisted electrochemical purification apparatus of the present invention.

FIG. 5 is a diagram of a second embodiment of the cavitation-assisted electrochemical purification apparatus of the present invention.

FIG. 6 is a diagram of a third embodiment of the cavitation-assisted electrochemical purification apparatus of the present invention.

FIG. 7 is a microphotograph of copper crystals taken with a SEM.

FIG. 8 is a computer-generated diagram of an experimental cavitation-assisted electrolytic purification system 500.

### DESCRIPTION OF THE PREFERRED EMBODIMENTS

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

The method and process described in the embodiments below applies to one or more chemical elements and/or compounds bonded in known and unknown fashions and present in a source feedstock. A “source feedstock” may be a product of mining such as copper ore, iron ore, aluminum ore, or a semi-refined material that can benefit from additional purification. A source feedstock may also be an impure material such as silicon dioxide (sand or Quartz) from which it is desired to make a purified, crystalline derivative such as single-crystal silicon. In general, the methods and processes described herein comprise providing a cavitation-assisted electrolytic purification apparatus comprising an electrolyte and a source feedstock in a reaction zone; introducing element- and/or compound-specific oxidizers and reducing agents to the source feedstock, causing an electric current to flow through the reaction zone in contact with the feedstock, causing cavitation to occur within the reaction zone, and optionally modifying the temperature within the reaction zone. The final product, i.e., the target elements and/or compounds, forms by one or a combination of precipitation; crystallization; electro-formation; or condensation by oxidation, reduction, or a combination thereof.

Naturally, these steps may be repeated on the feedstock until the desired separation or purity of the elements and/or compounds results. Taken together, these steps break chemical bonds, reform compounds, and form elements by using a combination of kinetic and thermodynamic reactions programmable to each element and/or compound. As a result, these steps allow bond-specific, tailored chemical reactions to occur in order to target product formation.

A cavitation-assisted electrolytic purification apparatus for practicing the claimed process is disclosed in U.S. patent application Ser. No. 12/166,979 filed Jul. 2, 2008, incorporated by reference herein in its entirety.

Cavitation is the phenomenon of formation (irregardless of mechanism) of vapor bubbles in a fluid, in the region where the pressure of the fluid falls below its vapor pressure. Cavitation can be divided into two classes of behavior: inertial (or transient) cavitation, and non-inertial cavitation. Inertial cavitation is the process where a void or bubble in a liquid rapidly collapses, producing a shock wave. Non-inertial cavitation is the process where a bubble in a fluid is forced to oscillate in size or shape due to some form of energy (such as acoustic fields) input. Both types of cavitation may be exploited by the present invention.

For the purposes of this patent application, “acoustic energy” refers to all frequencies, as well as any radiation of any frequency or wavelength in the electromagnetic spectrum. Also for the purposes of this patent, acoustic energy, as well as any radiation of any frequency or wavelength in the electromagnetic spectrum, may be employed as a single frequency (wavelength) or any frequency combination thereof (as a discrete sum, difference, harmonics, sub-harmonics, overtones, series, etc.).

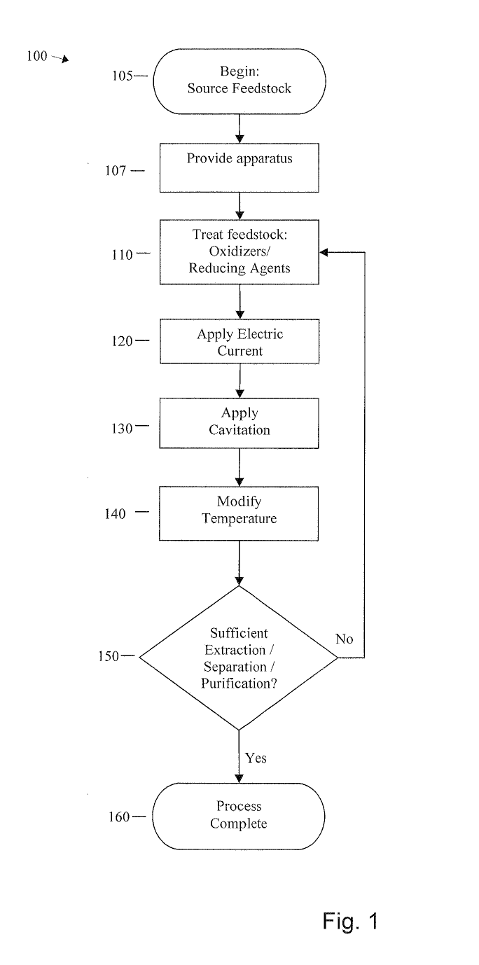

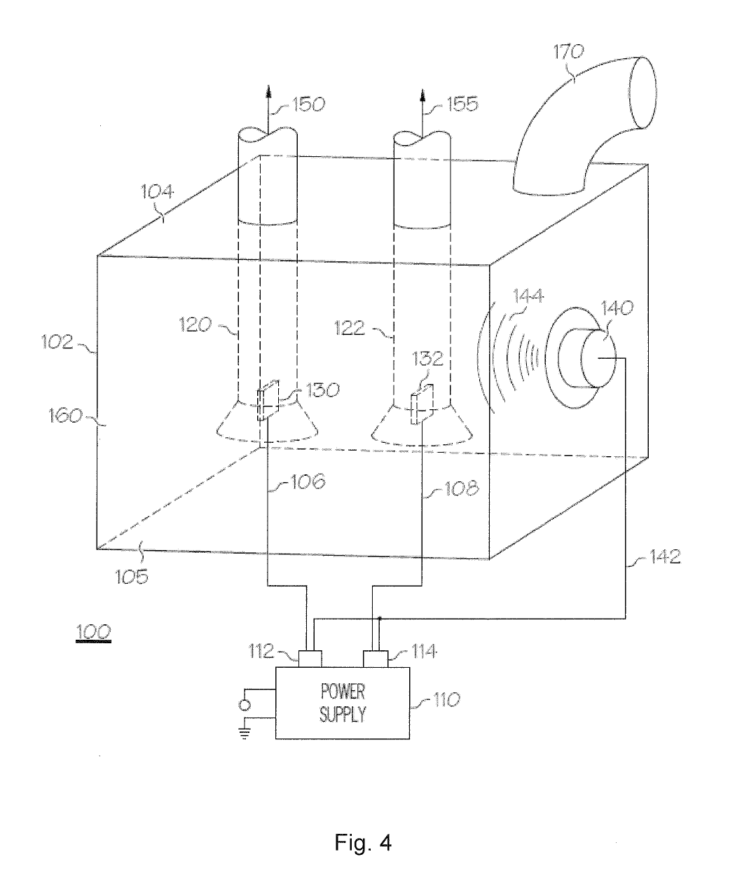

FIG. 1 is a flowchart depicting a first embodiment of the method and process of the invention. Method and process 100 begins with a source feedstock 105. Source feedstock 105 is any combination of elements and/or chemical compounds such as mined ore. Source feedstock 105 is situated in a container which contains a reaction zone where chemical processes and transformations occur. The reaction zone is located within an apparatus such as disclosed in FIGS. 4-6, and described more fully below under the heading “Cavitation-assisted Electrolytic Purification System.” The reaction zone is defined by the interval between and around the cathode and anode. The specific location of the reaction zone depends upon the precise arrangement of the cathode and anode. In a first embodiment shown in FIG. 4, the anode is the electrode connected to the positive terminal of the power supply, and thereby draws electrons from the solution. The cathode is connected to the negative side of the power supply and pushes electrons off its surface by making them available to positively-charged ions in solution such as, for example, Cu²⁺ ions, which then plate out of solution and onto the cathode purifying the Copper feedstock. In this embodiment the source feedstock will contain trace or even substantial amounts of metals that may be in electrical contact with the anode so that metals such as Cu can dissolve into solution as C²⁺ ions.

Referring back to FIG. 1, after providing a cavitation-assisted electrolytic purification apparatus as step 107, the first step of method and process 100 is the introduction of oxidation and reduction agents 110 to the source feedstock 105. The oxidation and reduction agents 110 are specifically chosen to correspond with the target elements and/or compounds that are to be extracted or separated from the source feedstock 105. The oxidation and reduction agents 110 act as reactants and/or catalysts, both in their own capacity as well as in conjunction with the application of electric current, cavitation, and heat or cold within the reaction zone, thereby lowering the barriers (activation energy) to the subsequent chemical reactions. Typical oxidizing agents include Hydrogen peroxide (H₂O₂) and other inorganic peroxides; Nitric acid and Nitrates; Chlorite, chlorate, perchlorate, and other analogous halogen compounds; Hypochlorite and other hypohalite compounds such as bleach; Fluorine and other halogens; Ozone, Nitrous oxide (N₂O), Silver oxide, Permanganate salts, Hexavalent chromium compounds such as chromic and dichromic acids and chromium trioxide, pyridinium chlorochromate (PCC), and chromate/dichromate compounds; Persulfuric acid; Sulfoxides; Sulfuric acid; Tollen's Reagent; 2,2′-Dipyridyldisulfide (DPS); Osmium tetroxide (OsO₄); and Iodide(I⁻) and lodate(IO³⁻) ions. Typical reducing agents include Lithium aluminium hydride PAIN; Nascent hydrogen; Sodium amalgam (NaHg); Sodium borohydride (NaBH₄); compounds containing the Sn²⁺ ion, such as Tin(II) chloride; Sulfite compounds; Hydrazine (Wolff-Kishner reduction); Zinc-mercury amalgam (Zn(Hg)) (Clemmensen reduction); Diisobutylaluminum hydride ((i-Bu₂AlH)₂); Lindlar catalyst; organic acids such as Oxalic acid (C₂H₂O₄), Formic acid (HCOOH), Ascorbic acid, Malic acid and Citric acid; phosphites, hypophosphites and Phosphorous acid; Dithiothreitol (DTT); and compounds containing the Fe²⁺ ion, such as iron(II) sulfate.

The second step of method and process 100 is the introduction of an electric current 120 within and through the reaction zone. The introduction of an electric current 120 within and through the reaction zone acts to supply electrons needed in the chemical reactions that take place during the extraction and separation process. This can also be thought of as the step of causing an electric current to flow through the reaction zone, which is performed by at least one negatively-charged electrode and at least one positively-charged electrode, which are adapted to energize the reaction zone. “Adapted to energize” means that the electrodes provide electrons to the electrolyte solution thereby driving the redox reaction electrolytically. The amount of the electric current 120 as well as the voltage required to drive such a current is specifically selected to correspond with target elements and/or compounds that are to be extracted or separated from the source feedstock 105. The reaction zone and electrolytic cell in general obey Ohm's Law. In a preferred embodiment, the total current is kept constant as the purification process proceeds. In the apparatus of FIGS. 4-6, a preferred voltage range is from about 2 volts to about 14 volts at 1.5 amps. A more preferred range is from about 5 volts to about 9 volts, and a most preferred range is from about 6 volts to about 8 volts. Resistance also is allowed to vary, but has not been measured.

The third step of method and process 100 is the introduction of cavitation 130 within the reaction zone. Generally, cavitation is the phenomenon of formation (regardless of mechanism) of vapor bubbles in a fluid, in a region where the pressure of the fluid falls below its vapor pressure. Cavitation can be divided into two classes of behavior: inertial (or transient) cavitation, and non-inertial cavitation. Inertial cavitation is the process where a void or bubble in a liquid rapidly collapses, producing a shock wave. Non-inertial cavitation is the process where a bubble in a fluid is forced to oscillate in size or shape due to some form of energy (such as acoustic fields) input. Regardless of the type of class, cavitation is a high energy process that causes or focuses endothermic reactions to produce exothermic reactions. In aqueous systems cavitation may be generated at one or more frequencies that are directed into the reaction zone. In one embodiment the frequencies may be in the ultrasound frequency region of from 20 kHz to about 100 kHz, in a more preferred embodiment the frequencies may be from about 20 kHz to about 40 kHz, and in a most preferred embodiment from about 20 to about 30 kHz.

Cavitation 130 may be caused within the reaction zone through a variety of means, including but not limited to, mechanical means, acoustic means, hydrodynamic means, electromagnetic means, and ionizing radiation means. Cavitation aids and/or causes the chemical reactions that take place during the extraction and separation process. Cavitation may aid chemical reactions by accelerating the reaction through catalysis or by lowering the activation energy of a given chemical reaction.

FIG. 4 shows an embodiment of the present invention wherein the cavitation is produced by a specific acoustic means, namely, by using a transducer to pass acoustic energy waves through solution 160. However, other acoustic means can be used to produce the cavitation. It will be understood by one having skill in the art that such acoustic means includes, but are not limited to, transducers, microphones, and speakers. A preferred transducer is a Piezo Air Transducer, Part No. SMUTF40TR18A, Steminc (Steiner & Martins, Inc.), Miami, Fla., with a nominal frequency of 40 kHz. Power for driving the transducers is supplied by any suitable function generator can be used to drive the transducers, but preferred generators include a PROTEK B8012, or a QUAKKO 5000 digital signal generator. The transducers were set at 3.3 V, and drew about 10-20 mA. Frequencies were set at 38.248 kHz for the transverse/horizontal transducer, and 76 kHz for the bottom transducer. However, it is well-known that there are numerous types of ultrasonic transducers that may be used to generate cavitation in a liquid such as those used in sonication cleaning baths which typically operate in the 40 kHz range.

The fourth step of method and process 100 is the modification of the temperature within the reaction zone. The temperature is modified by applying heat or cold to the reaction zone where the heat or cold is specifically chosen to correspond with the target elements and/or compounds that are to be extracted or separated from the source feedstock 105. Like cavitation, the modification of the temperature within the reaction zone aids and/or causes the chemical reactions that take place during the extraction and separation process. It will be clear to one skilled in the art that step 140 may include maintaining a constant temperature throughout the application of steps 110, 120, and 130, that is, making no modification to the reaction zone temperature, where no such modification is required in order to produce the desired element and/or compound.

Upon completion of the four steps 110, 120, 130, and 140 an examination 150 may be made to determine if the method and process 100 produced the desired extraction, separation, or purity of the target elements and/or compounds. If further extraction, separation, or purity is required, then the steps 110, 120, and 130 may be repeated until the desired outcome is achieved. Once the desired outcome is achieved, then the process is complete.

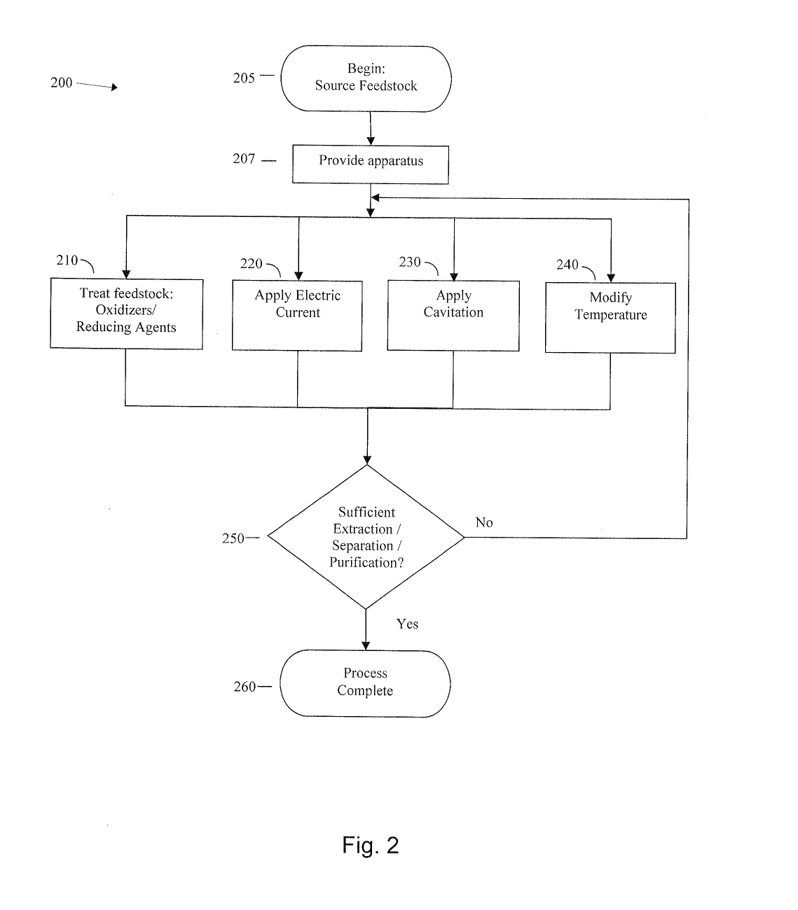

FIG. 2 is a second embodiment of the method and process. Method and process 200 begins with a source feedstock 205. As stated above for method and process 100, source feedstock 205 is any combination of elements and chemical compounds. Source feedstock 205 is situated in a container which contains a reaction zone where chemical processes and transformations occur.

In method and process 200, source feedstock is subjected to the simultaneous steps of the introduction of oxidation and reduction agents 210 to the source feedstock 205, the application of an electric current 220, and cavitation 230, within and through the reaction zone, as well as the modification of the temperature 240 within the reaction zone.

The oxidation and reduction agents in step 210, the amount of electric current applied in step 220, the amount of cavitation applied in step 230, and the modification of the temperature within the reaction zone in step 240, are selected as described above in method and process 100.

Upon completion of the four steps 210, 220, 230, and 240, an examination 250 may be made to determine if the method and process 200 produced the desired extraction, separation, or purity of the target elements and/or compounds. If further extraction, separation, or purity is required, then the steps may be repeated until the desired outcome is achieved. Once the desired outcome is achieved, then the process is complete.

It will be clear to one skilled in the art that the order of the steps described in the above embodiments, the time duration of each step, and whether or not one or more steps occurs in series or simultaneously with one or more other steps, may be altered depending on the target element(s) and/or compound(s) that are to be extracted and separated from the source feedstock. Thus, the steps described in the above embodiments may occur either serially, with any individual step or combination of the steps occurring before any other individual step or combination of the steps, or all steps may occur simultaneously, without affecting the scope and spirit of the invention.

Regarding steps 120 and 220, introducing an electric current within and through the reaction zone, described above, it will be clear to one skilled in the art that the introduction of an electric current within and through the reaction zone may be accomplished by a variety of means, including but not limited to, placing a positively-charged electrode (anode) and negatively-charged electrode (cathode) in, adjacent to, or across the reaction zone where the electrical current flows between the cathode and the anode.

Regarding steps 130 and 230, causing cavitation within the reaction zone, described above, it will be clear to one skilled in the art that the introduction of cavitation within the reaction zone may be caused by any one, or combination, of acoustic means, mechanical means, hydrodynamic means, electromagnetic means, and ionizing radiation means.

Acoustic means include, but are not limited to, transducers, microphones, and speakers. The acoustic energy imparted by such acoustic means includes all frequencies and one or more specific acoustic frequencies, with or without modulation, may be utilized according to the desired target element(s) and/or compound(s). Mechanical means include, but are not limited to, a propeller system, pistons, shock tubes, and light gas guns. Hydrodynamic means include, but are not limited to, compressed gas injection and any devise capable of transferring momentum into the reaction zone without transferring additional mass into the reaction zone, such as a shock plate or orbital shaker. Electromagnetic means includes, but is not limited to, a laser beam(s), x-rays, gamma rays, high-speed electrons, electric arc, magnetic compression, plasma generation, and electromagnetic radiation arising from any type of electron or proton reaction. Finally, ionizing radiation means includes, but is not limited to, passing high energy protons into the reaction zone, all electromagnetic radiation greater in energy than ultraviolet radiation, and high energy particles such as photons, neutrons, and charged and uncharged nuclei.

It has been advantageously shown that use of an effective amount of noble gas, for example argon or xenon, in the source feedstock promotes rectification in the reaction zone thereby promoting chemical reactions. Likewise, it has been shown that the use of an effective amount of noble gas promotes the general cavitation process. In the present embodiments, the noble gas is preferably argon, and the effective amount of noble gas is dependent on the target element(s)' and/or compound(s)' equation(s) of state, however up to 5% argon dissolved in solution has previously been shown effective. It will be clear to one skilled in the art that the introduction of such noble gas into the reaction zone may be part of steps 110 or 210, the introduction of oxidation and reduction agents to the source feedstock 105 or 205, or may be part of steps 130 or 230, the application of cavitation within the reaction zone.

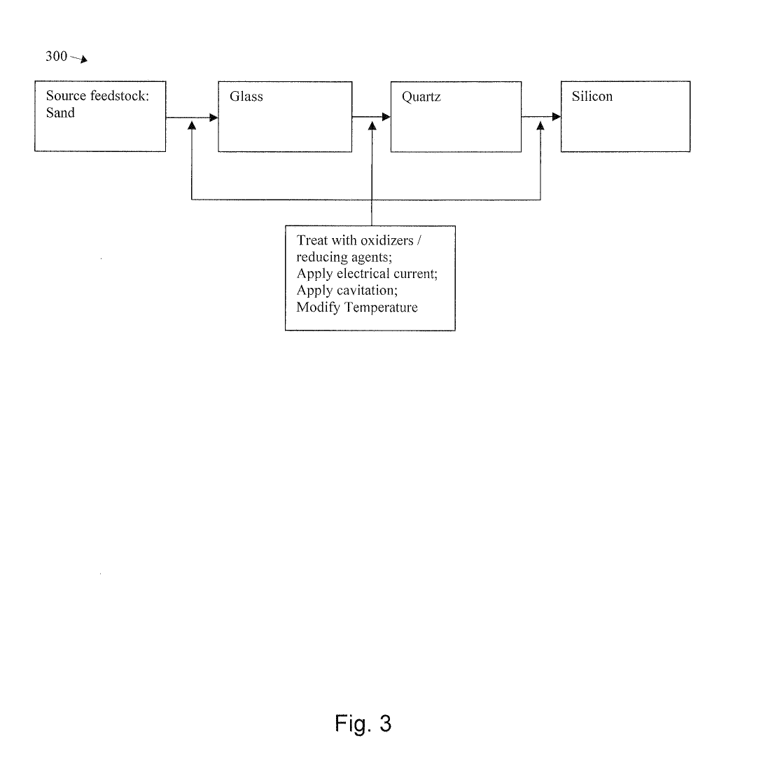

FIG. 3 shows a flowchart depiction where the method and process described in the embodiments above are applied to the process of converting impure SiO₂ into ultra-pure, single-crystal grade silicon. The silicon production process 300 starts with a source feedstock such as raw SiO₂. Method and process 100 or 200 is applied to the raw feedstock. The temperature must be sufficiently high to melt the silicon dioxide, which is at a minimum of 1723 degrees C. Upon a temperature sufficient to melt the source feedstock, introduction of electrical current at sufficient potential to induce electron flow in the molten state (by the Nernst equation where the minimum free energy, ΔG has been reached) will allow for reduction and expulsion of contaminant elements in the SiO₂. I.e., the expulsion of hydrogen gas from water decomposition in molten SiO₂. With application of cavitation, the process of elemental reduction and removal of contaminants is enhanced and accelerated by the introduction of implosive shock.

Upon completion of steps 110, 120, 130, and 140, or the simultaneous application of steps 210, 220, 230, and 240, as the case may be, the SiO₂ has been processed into pure molten quartz. Method and process 100 or 200 is repeated at least two more times, once to process the glass into quartz, and at least once more to process the quartz into pure, elemental silicon. Method and process 100 or 200 may continue to be repeated in order to increase the purity of the produced silicon. Upon obtaining the required purity level of silicon, the process is complete.

For example, to remove trace levels of contaminant water from molten SiO₂, simply boiling SiO₂ will remove the water by the process of bubble formation from heat nucleation sites in the container. However, this process is slow and by inducing acoustic cavitation the process of bubble formation and collapse is sped up by at least 1-2 orders of magnitude. This faster formation and collapse allows for cavitation-induced high-energy chemical reactions to occur. These high-energy reactions will allow for the reduction of elements such as oxygen and hydrogen to their lowest energy ΔG states, i.e., as O₂ and H₂ gas, thereby permitting their rapid expulsion. Reduction to pure silicon from pure SiO₂ is then accomplished by continuing this process by the introduction of hydrogen gas into the molten electrolyte, thereby inducing a series of reactions (Si—O+H⁺→H₂O→H₂+O₂) all of which lead to thermodynamically lower ΔG states.

In another example, the method and process described in the embodiments above are applied to the process of extracting gold from ore. In this example the ore is introduced to a water-based solution to create the source feedstock 105 or 205. Method and process 100 or 200, or some other combination of the steps embodied therein, is applied to the ore feedstock as an acid treatment comprising hydrochloric acid, nitric acid, or some combination thereof to oxidize the gold ions to either the I or II oxidation state as step 110. The application of sufficient electric current at potential E°=1.52 V as step 120 will reduce all Au I to elemental gold, followed by successive applications of sufficient electric current at potentials to reduce each species of gold ion as in solution until all gold in solution has been reduced to metal, also as step 120, in conjunction with cavitation as step 130 to increase rate and improve efficiency. The temperature may be modified as step 140 to adjust rate and yield, and will depend on the relative viscosity and conductivity of the solution.

The Standard IUPAC Reduction Potentials for gold, as reported by A. J. Bard, R. Parsons and J. Jordan, Standard Potentials in Aqueous Solutions, IUPAC (Marcel Dekker), New York, USA (1985) appears in the table below:

Upon completion of steps 110, 120, 130, and 140, or the simultaneous application of steps 210, 220, 230, and 240, as the case may be, the gold is precipitated upon an electrode used to produce the electrical current in step 120 or 220. Method and process 100 or 200 may be repeated until no further gold precipitates on the electrode indicating that all gold has been extracted from the ore. It is clear from this example, that the gold is capable of being separated from the ore without the use of mercury or cyanide.

Method and process 100 or 200, or some other combination of the steps embodied therein, is applied to the ore feedstock. Upon completion of steps 110, 120, 130, and 140, or the simultaneous application of steps 210, 220, 230, and 240, as the case may be, the gold has precipitated upon an electrode used to produce the electrical current in step 120 or 220. Method and process 100 or 200 may be repeated until no further gold precipitates on the electrode indicating that all gold has been extracted from the ore. It is clear from this example, that the gold is capable of being separated from the ore without the use of mercury or cyanide.

FIG. 4 is a cross-sectional side view of a first embodiment of the cavitation-assisted electrolytic purification system 100 according to the present invention. Cavitation-assisted electrolytic purification system 100 consists of a container apparatus 102 in the fashion of an electrolytic cell capable of storing a volume of a solution 160. Solution 160 is comprised of a solvent and solute. In a first embodiment the solvent is preferably water, and in another embodiment another aqueous solution containing hydrogen. By way of non-limiting examples, alcohols such as methanol, ethanol, butanol etc, are also hydrogen-containing solutes that may be mixed with or as replacements for water. The solute must be capable of being an electrolyte, that is, solvating ions. The solute is a chemical compound capable of carrying an electrical charge i.e. an electrolyte. Preferred electrolytes are inorganic salts such as potassium iodide (Kl), NaCl, or similar metal salts. Also preferred are organic acid electrolytes such as citric acid, malic acid and similar water-soluble organic acids, having a sufficiently high pKa to dissociate to contribute to the charge density of the solution. The sides of container apparatus 102 are preferably non-electrically conductive. Two electrically-conductive electrodes 130 and 132 are held above the bottom member 105 of container apparatus 120 by supporting members 106 and 108, respectively. The electrode 130 is connected to the negative terminal 112 of power supply 110. Thus, the electrode 130 is a cathode. Likewise, the electrode 132 is connected to the positive terminal 114 of power supply 110. Thus, the electrode 132 is an anode. A hollow, cylindrical tube 120 is connected to and passes though top member 104 of container apparatus 102. The bottom of tube 120 is flared outward and positioned so that the bottom of tube 120 is below the bottom of cathode 130 but not touching bottom member 105 of container apparatus 102. Likewise, a hollow, cylindrical tube 122 is connected to and passes through top member 104 of container apparatus 102. The bottom of tube 122 is flared outward and positioned so that the bottom of tube 122 is below the bottom of anode 132 but not touching bottom member 105 of container apparatus 102. Finally, a transducer 140 is connected to one side of container apparatus 102. Wires 142 connect transducer 140 to power supply 110.

As previously mentioned, power supply 110 causes cathode 130 to be negatively charged and anode 132 to be positively charged. As a result, an electrical current is created between cathode 130 and anode 132. The electrical current electrolyzes solution 160 and any source feedstock in electrical contact with the anode and may cause hydrogen to form as a by-product around cathode 130 and oxygen to form around anode 132. Tube 120 funnels the hydrogen out of container apparatus 102 for use further use or disposal (shown by arrow 150). Likewise tube 122 funnels the oxygen out of container apparatus 102 (shown by arrow 155). As solution 160 is electrolyzed and the constituent gases are removed from the system 100, additional solution can be added through an inlet 170.

Purification of metals from source feedstocks such as metal ores like gold, silver, bauxite, copper ores, etc. may also be extracted and purified using the process and apparatus described herein. A reaction zone is located within the apparatus such as disclosed in FIGS. 4-6. The reaction zone is defined by the interval between and around the cathode and anode, and also by the convergence of ultrasound radiation. The specific location of the reaction zone depends upon the arrangement of the cathode, anode, and the positioning of the transducers. In one embodiment shown in FIG. 4, the anode is the electrode connected to the positive terminal of the power supply, and thereby draws electrons from ions in the solution, or alternatively it oxidizes ions at the anode. The cathode is connected to the negative side of the power supply and pushes electrons off its surface by making them available to positively-charged ions in solution such as, for example, Cu²⁺ ions, which are reduced and then plate out of solution and onto the cathode purifying the Copper feedstock. In this embodiment the source feedstock will contain trace or even substantial amounts of metals that may be in electrical contact with the anode so that metals such as Cu can dissolve into solution as Cu²⁺ ions. Metals may be electrolytically recovered using standard electrolytic purification processes such as are outlined in detail in Chemical Metallurgy, C K Gupta, Wiley-VCH (2003). For example, in the purification of Copper ore an impure copper anode may be the sacrificial electrode, and the copper is dissolved into a starting solution of CuSO4 and plates out on a cathode. Source feedstock may be substituted for the anode, or the source feedstock may be in electrical contact with the anode and cavitation added to the process so that enhanced purification of copper results, as further disclosed in the examples following.

Transducer 140 produces acoustic energy waves 144 which transmit through and cause cavitation in solution 160. It is a theory of the invention that this cavitation decreases the energy required to break the chemical bonds of solution 160 and/or the source feedstock, however the inventors should not be held to any particular theory underlying the invention. As a result, in the presence of cavitation, a greater amount of purification occurs at the cathode at a given voltage than in the absence of cavitation. Alternatively, in the presence of cavitation, the same amount of purification occurs at the cathode at a lower voltage than in the absence of cavitation.

Cavitation-assisted electrolytic purification system 100 is designed to be portable. However, it is clear to one skilled in the art that cavitation-assisted electrolytic purification system 100 and its components can be scaled larger or smaller without affecting the spirit and scope of the present invention. Likewise, it is clear to one skilled in the art that cavitation-assisted electrolytic purification system 100 and its components can take on many different shapes without affecting the spirit and scope of the present invention. FIG. 4 shows one embodiment of the present invention where container apparatus 102 is shaped to allow maximum transmittal of sound waves 144 though solution 160. Finally, it is clear to one skilled in the art that any number of transducers 140 may be placed at various locations on container apparatus 102 and used to produce acoustic energy waves 144 in order to maximize the creation of cavitation within solution 160 and the source feedstock.

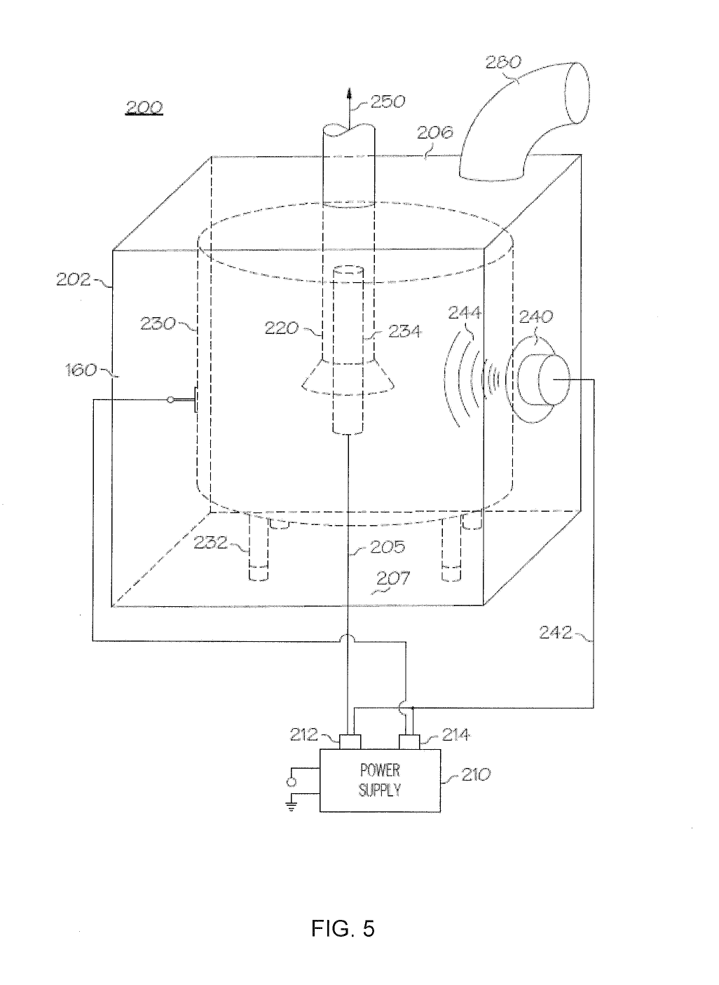

FIG. 5 is a cross sectional side view of a second embodiment, referred to as cavitation-assisted electrolytic purification system 200, of the present invention. The principal differences between system 100 and system 200 include concentric electrodes in the second embodiment (anode outside of the cathode), and a surrounding electrically grounded container apparatus 202. Cavitation-assisted electrolytic purification system 200 consists of a container apparatus 202 in the fashion of an electrolytic cell capable of storing a solution 160, and a source feedstock. The sides of container apparatus 202 are preferably non-electrically conductive and grounded for safety purposes. A hollow, cylindrical electrode 230 is held above the bottom member 207 of container apparatus 202 by supporting members 232. A second electrode 234 is held above the bottom member 207 of container apparatus 202 by supporting member 205. Electrode 230 is connected to the positive terminal 214 of power supply 210. Thus, electrode 230 is an anode. Likewise, electrode 234 is connected to the negative terminal 212 of power supply 210. Thus, electrode 234 is a cathode, A hollow, cylindrical tube 220 is connected to and passes through top member 206 of container apparatus 202. The bottom of tube 220 is flared outward and positioned so that some portion of cathode 234 is within the tube 220. Finally, a transducer 240 is connected to one side of container apparatus 202. Wires 242 connect transducer 240 to power supply 210.

Power supply 210 and its interconnections are substantially the same as in the first embodiment, although numbering of the constituent parts is different. A complete list of parts is reproduced after the Detailed Description portion of the specification.

Cavitation-assisted electrolytic purification system 200 is the same as cavitation-assisted electrolytic purification system 100 in that transducer 240 produces sound waves 244 which transmit through and cause cavitation in solution 160 and or the source feedstock. It is the current theory that this cavitation decreases the energy required to break the chemical bonds of solution 160 and/or the source feedstock via electrolysis, although the inventors should not be held to any theory of operation underlying the invention. As a result, in the presence of cavitation, a greater amount of purification occurs at cathode 234 at a given voltage than in the absence of cavitation. Alternatively, in the presence of cavitation, the same amount of purification occurs at cathode 234 at a lower voltage than in the absence of cavitation.

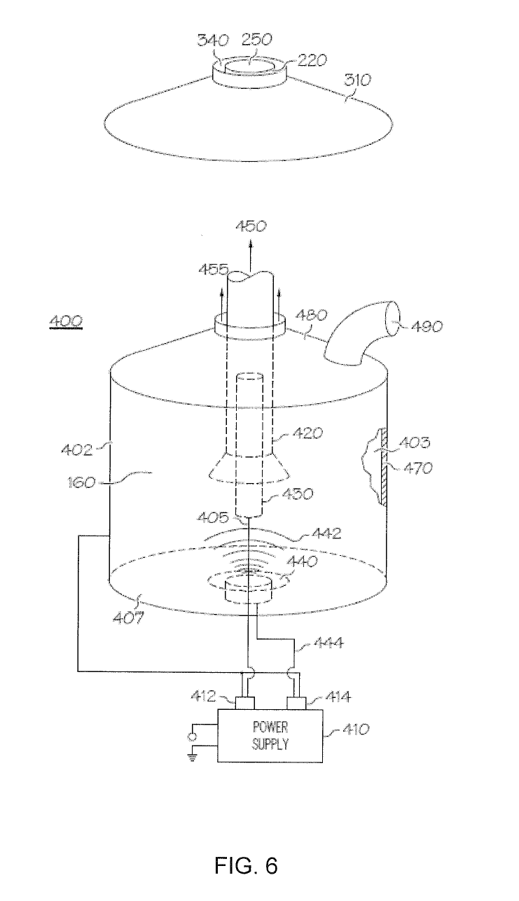

FIG. 6 is a cross sectional side view of a third embodiment of the invention, referred to as cavitation-assisted electrolytic purification system 400, of the present invention. System 400 differs from system 200 in that system 400 is designed to also capture oxygen generated at the anode, and the ultrasonic transducer is situated so as to broadcast coaxial to the electrodes as opposed to transversely. Cavitation-assisted electrolytic purification system 400 consists of a cylindrically-shaped container apparatus 402 in the fashion of an electrolytic cell capable of storing a solution 160 and/or a source feedstock. Container apparatus 402 has an electrically conductive inner wall 403 and a non-electrically conductive outer wall 470. Cathode 430 held above the bottom member 407 of container apparatus 402 by supporting member 405. Electrically conductive inner wall 403 is connected to the positive terminal 414 of power supply 410. Thus, conductive inner wall 403 also functions as an anode. Cathode 430 is connected to the negative terminal 412 of power supply 410. A hollow, cylindrical tube 420 is connected to and passes through the top member 480 of container apparatus 402, principally to collect any hydrogen generated as a by-product of purification. The bottom of tube 420 is flared outward and position so that some portion of cathode 430 is within tube 420. Finally, a transducer 440 is connected to bottom member 407 of container apparatus 402. Wires 444 connect transducer 440 to power supply 410.

Power supply 410 causes cathode 430 to be negatively charged and anode 403 to be positively charged. As a result, an electrical current is created between cathode 430 and anode 403. The cylindrical shape of anode 403 and the position of cathode 430 along the axis of anode 403 takes advantage of the electrical field produced by cathode 430 and anode 403 and helps to maximize the flow of electricity between cathode 430 and anode 403.

As previously described, the electrical current flowing between cathode 430 and anode 403 electrolyzes solution 160 and any source feedstock in electrical contact with the anode may cause hydrogen as a by-product to form around cathode 430 and oxygen to form around anode 403. Tube 420 funnels the hydrogen out of container apparatus 402 for further use (shown by arrow 450). Conically-shaped top member 480 of container apparatus 402 funnels oxygen out of container apparatus 402 (shown by arrow 455). Referring to FIG. 6, a conical piece 310 is placed on top of anode 403. Conical piece 310 funnels oxygen out of container apparatus 402 (shown by line 340). As solution 160 and source feedstock are electrolyzed and the by-product gases are removed from the system 100, additional solution can be added through an inlet 490.

Cavitation-assisted electrolytic purification system 400 is the same as cavitation-assisted electrolytic purification systems 100 and 200 in that transducer 440 produces acoustic energy waves 442 which transmit through and cause cavitation in solution 160 and/or the source feedstock.

Cavitation-assisted electrolytic purification system 400 is also designed to be portable. However, it is clear to one skilled in the art that cavitation-assisted electrolytic purification system 400 and its components can be scaled larger or smaller without affecting the spirit and scope of the present invention. Likewise, it is clear to one skilled in the art that Cavitation-assisted electrolytic purification system 400 and its components can take on many different shapes without affecting the spirit and scope of the present invention. Finally, it is clear to one skilled in the art that any number of transducers 440 may be placed on container apparatus 402 and used to produce sound waves 442 in order to maximize the creation of cavitation within solution 160 and/or the source feedstock,

Throughout the descriptions of cavitation-assisted electrolytic purification systems 100, 200, and 400, a cylindrical tube, tube 120, 250, and 420, is used to capture hydrogen formed around the cathode and direct the hydrogen out of the systems. It will be clear to one skilled in the art that tubes 120, 250, and 450 can be replaced by any means to capture and direct the hydrogen. Such means include, but are not limited to, tubes and similarly shaped conduits, membrane filtering, diffusive evaporation, differential pressures, and channeling solution flow. The previous comments also apply to oxygen formed at the anode.

### EXAMPLES

1. Purification of Copper Nanocrystals from Copper Pipe Feedstock

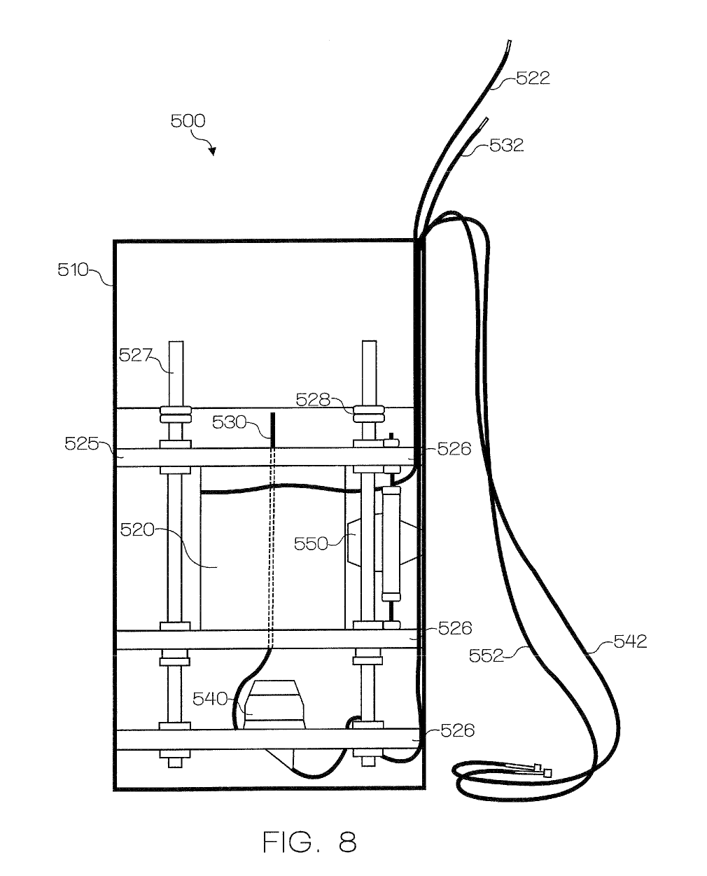

The experimental cavitation-assisted electrolytic purification apparatus used in this example is shown in FIG. 8 and described as follows. The apparatus 500 generally conforms to the apparatus described as the third embodiment (FIG. 6), with the addition of one more ultrasound transducer. A container for holding liquids such as aqueous electrolyte is indicated as 510. The components of an electrolytic cell are inside container 510, the cell being comprised of a cylindrical copper anode 520 mounted in an electrode assembly 525; a cylindrical cathode 530 located inside the anode 520; an ultrasonic bottom transducer 540 mounted under the electrode assembly 525 and directed vertically along the axis of the cathode 530; and a transverse transducer 550 mounted at a 90 degree angle to the bottom transducer 540. Not shown are the electronics for driving the transducers, power supply for the electrodes, or a gas removing means for removing any evolving gases.

Electrode assembly 525 is a conventional support assembly comprising three support plates 526 oriented horizontally and having cutout portions where appropriate. They are made from NYLON® (DuPont, Wilmington, Del.) approximately ¼ inch in thickness. The three plates are held in horizontal orientation by four tie rods 527 which are metal, preferably stainless steel, and are threaded to accept knurled nuts 528. There are also power leads for the anode lead 522 and a cathode lead 532. Power to the bottom and transverse transducers was applied through leads 542 and 552, respectively.

The cylindrical anode 520 was made from solid copper pipe having dimensions 5.4 cm OD by 5.1 cm ID, and a height of 6 cm; Grainger, Copper streamline tube, Fulton, MS Type M NSE/ANSI, 61-G. The cathode 530 is two pieces, a central 14-gauge copper wire (2 mm OD), and a cylindrical solid copper mesh slipped over it, approximately 2 mm OD, 2 mm ID, height 6 cm; 99.9% pure copper mesh; 0.010 thick; Stock no. 6095; K&S Engineering. The cathode shape is that of a concentric cylinder sitting at a fixed ratio of approximately 1:25 relative to and inside the anode, as measured according to the inside diameter of the outer anode compared to the outside diameter of the inner cathode. The cathode was located concentrically along the axis of the anodic volume. The copper wire was sourced from Home Depot, and is 99.9% pure copper wire—14 gauge; 600 volt; VW-1 rated; Issue No. YM-680,590.

A power supply (30 volts/3 amps) (3 channel programmable BK Precision Model 903) was used to power the electrolytic purification process. In addition, Whatman Grade No. 42 Quantitative Ashless Filter Paper, Cat no. 14-42-110 was used for filtering the copper nanocrystals. A frequency generator drives the transducers.

The electrolyte is an aqueous solution of citric acid, NaCl and Nal. 121.731 g NaCl, ACS grade reagent, Aqua Solutions, Deer Park, Tex., Cat. No. 62675-2KG was dissolved in 2 liters of water purified by reverse osmosis. Next, 20.560 g Citric Acid-ACS grade ACROS, Cat No. 42356-0020 is dissolved in the same solution. Then 3.54 mg Reagent grade Nal from MP Biomedicals, Solon, Ohio, Cat No. 193979 is dissolved in the electrolyte solution.

The process was run according to the following protocol. First, the electrolyte solution was “charged” or brought to potential. Priming or charging is the process of applying an electric potential to the solution which retains a portion of the charge throughout and after the reaction has concluded. The solution possesses a complex dielectric function e and thus functions similar to a resistive capacitive network. This step is required of all methods to induce nanocrystal growth. Bringing the solution to potential alleviates the delay normally associated with initializing electrolysis. On a molecular level, this causes the ion channels to start “flowing,” and promotes electron exchange. The initial runs to bring the solution to potential are relatively straight-forward. The electrolyte in the apparatus was brought to a set current of 1.5 Amps with the voltage set at 20V. When the current approached the set value of 1.5 Amps, the voltage was observed to be between 6-8 volts. The solution was held at these values for approx. 5 minutes and then the power applied was turned off. This particular procedure was carried out at least once, sometimes twice. At this point, the solution was considered to be charged (at potential).

The positive lead was attached to the anode; the negative lead was attached to the cathode. The transducers were attached to the function/frequency generator (if using cavitation). The power supply was set to float with a voltage ceiling of 20V, while the amperage was set at a fixed value (which ranges from 250 mA to 2.0 A). The variance in amperage is to determine whether or not the growth time and/or quantity of nanocrystals are constant or variable. Any suitable function generator can be used to drive the transducers, but preferred generators include a PROTEK B8012, or a QUAKKO 5000 digital signal generator. The transducers were set at 3.3 V, and drew about 10-20 mA. Frequencies were set at 38.248 kHz for the transverse/horizontal transducer, and 76 kHz for the bottom transducer. The transverse transducer 550 was located 2.6 cm from the center of the cell; the bottom transducer 540 was located 5.2 cm from the center measured from the face of the transducer. Both transducers were oriented towards the center of the cell. The central area of the cell is thus considered the “reaction zone” for purposes of this experimental apparatus 500. The transducer used in the present invention was a Piezo Air Transducer, Part No. SMUTF40TR18A, Steminc (Steiner & Martins, Inc.), Miami, Fla.

After observing that copper nanocrystals grew in both the solution as well as on the cathode the nanocrystals were washed with distilled H₂O (di-H₂O) to remove any residues. This wash cycle was repeated a total of three times. The nanocrystals were then filtered through a wire mesh filter and then through a Whatman Grade No. 40 Quantitative Ashless Filter Paper, placed in a small funnel placed atop an Erlenmeyer flask or similar collection device. When dried, the crystals were placed and stored as a “suspension” of anhydrous ethanol to reduce atmospheric oxidation, although other methods may be employed such as storage under dry inert gas. The copper nanocrystals were analyzed by electron diffraction x-ray, (SEM/EDX) and found to be pure copper metal at the University of Arizona.

The inventors have observed that copper is purified in the volume of the reaction zone, and not just on the surface area of the cathode. During the experiments it was observed that hydrogen gas and/or copper nanocrystal formation is accomplished in an annular ring of fluid surrounding the inner cathode, instead of simply on the surface of the inner cathode.

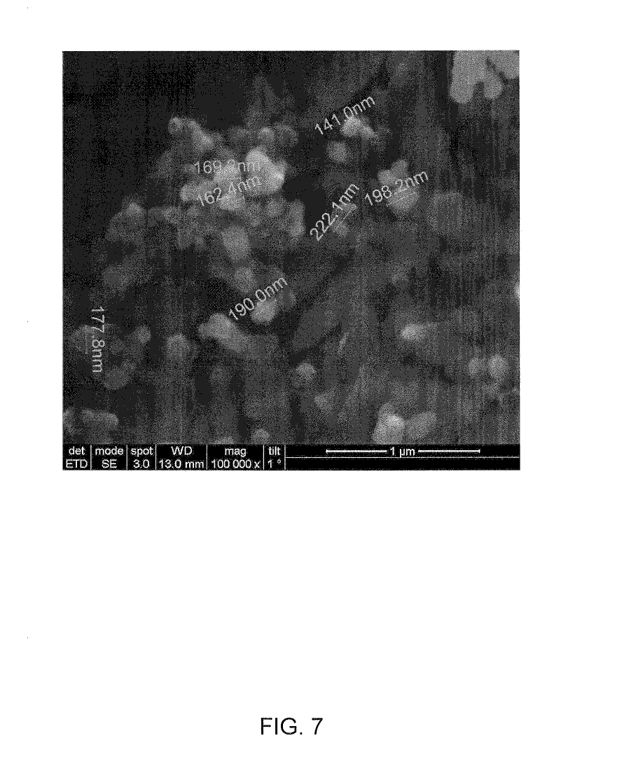

Results of the protocol are shown in the photomicrograph of FIG. 7. Copper crystals, ranging in size from 140 nM to 7 μM, are shown in the photograph. The photomicrograph was taken on a scanning electron microscope at the University of Arizona, Keck Imaging Center, on a FEI Inspect Model S (Czech Rep.).

Although a specific embodiment of the invention has been disclosed, it will be understood by those having skill in the art that changes can be made to this specific embodiment without departing from the spirit and scope of the invention. Likewise, it will be understood by those having skill in the art that the teachings herein can be scaled in size to increase or decrease the amount of the desired element(s) and/or compound(s) separated from the source feedstock without affecting the scope and spirit of the present invention. The scope of the invention is not to be restricted, therefore, to the specific embodiments, and it is intended that the appended claims cover any and all such applications, modifications, and embodiments within the scope of the present invention.

1. A method for separating and extracting one or more desired elements and/or compounds from a source feedstock comprising the steps of:
providing a cavitation-assisted electrolytic purification apparatus comprising an electrolyte and a source feedstock in a reaction zone;
introducing oxidizing agents and reducing agents to the source feedstock;
causing an electric current to flow through the reaction zone;
causing cavitation within the reaction zone; and
optionally modifying the temperature of the reaction zone.

2. The method according to claim 1, wherein the source feedstock is in or adjacent to the reaction zone.

3. The method according to claim 1, wherein the step of introducing oxidizing agent and reducing agents to the source feedstock further comprises introducing an effective amount of noble gas to the source feedstock.

4. The method according to claim 1, wherein the step of causing an electric current to flow through the reaction zone is performed by at least one negatively-charged electrode and at least one positively-charged electrode adapted to energize the reaction zone.

5. The method according to claim 1, wherein the step of causing cavitation within the reaction zone further comprises introducing an effective amount of noble gas to the aqueous electrolyte.

6. The method according to claim 1, wherein the step of causing cavitation within the reaction zone is performed using at least one of any acoustic means, mechanical means, hydrodynamic means, electromagnetic means, and ionizing radiation means.

7. The method according to claim 1, wherein the step of causing cavitation within the reaction zone is performed using any combination of any acoustic means, mechanical means, hydrodynamic means, electromagnetic means, and ionizing radiation means.

8. The method according to claim 1, wherein the optional step of modifying the temperature of the reaction zone further comprises increasing or decreasing the temperature of the reaction zone to maximize the production of the desired element(s) and/or compounds(s) from the source feedstock.

9. The method according to claim 1, wherein the optional step of modifying the temperature of the reaction zone includes maintaining a constant temperature within and throughout the reaction zone.

10. The method according to claim 1, wherein the source feedstock comprises at least one of sand, glass, or quartz, and wherein the steps are repeated until silicon with a desired purity is produced.

11. The method according to claim 1, wherein the source feedstock is gold-containing ore, wherein the step of causing an electric current to flow through the reaction zone is performed by at least one negatively-charged electrode and at least one positively-charged electrode adapted to energize the reaction zone, and wherein the steps are repeated until the gold has precipitated onto an electrode.

12. The method according to claim 1 wherein the source feedstock is copper-based and wherein the step of causing an electric current to flow through the reaction zone is performed by at least one negatively-charged electrode and at least one positively-charged electrode adapted to energize the reaction zone, and wherein the steps are repeated until copper metal has precipitated onto an electrode.

13. The method according to claim 12 wherein the copper source feedstock is semi-refined.

14. The method according to claim 13 wherein the copper feedstock is in electrical communication with a copper anode.

15. The method according to claim 12 wherein the aqueous electrolyte comprises citric acid, sodium chloride, sodium iodide and a noble gas.

16. The method according to claim 12 wherein the cavitation comprises acoustic cavitation.

17. The method of claim 16 wherein the acoustic cavitation frequency range is from about 15 kHz to about 100 kHz.

18. The method according to claim 12 wherein the cathode comprises copper mesh.

19. The method according to claim 18 wherein the purified copper comprises crystalline copper particles that accumulate on the cathode.

20. The method according to claim 12 wherein hydrogen is generated at the cathode as a by-product.

21. The method of claim 12 wherein the purified copper comprises crystalline copper that precipitates from solution in the reaction zone.

22. The method of claim 1 wherein the steps may occur either serially, with any individual step or combination of steps occurring before any other individual step or combination of steps, or simultaneously.
